(19) United States
(12) Patent Application Publication
(10) Pub. No.: US 2010/0007591 A1
(43) Pub. Date: Jan. 14, 2010

(54) PIXEL UNIT FOR A DISPLAY DEVICE AND DRIVING METHOD THEREOF

(75) Inventors: Cheng-Chi Yen, Tainan County (TW); Hon-Yuan Leo, Tainan County (TW); Ju-Tien Cheng, Tainan County (TW); Yen-Chen Chen, Tainan County (TW)

Correspondence Address: J C PATENTS, 4 VENTURE, SUITE 250, IRVINE, CA, 92618, US

(73) Assignee: Himax Display, Inc., Tainan County (TW)

(21) Appl. No.: 12/170,631

(22) Filed: Jul. 10, 2008

(51) Int. Cl. G09G 3/36

(52) U.S. Cl. 345/89

(57) ABSTRACT

A pixel unit and driving method thereof are disclosed. The pixel unit includes a switch, a storage element and a first multiplexer. The switch develops a charge transfer path according to a scan signal associated with a scan line. The storage element has a first electrode coupled to the switch and a second electrode coupled to a reference voltage for receiving a pixel voltage via the charge transfer path. The first multiplexer is coupled to the second electrode of the storage element for selectively providing the reference voltage with a default value and the reference voltage with a determined value to the second electrode of the storage element according to a modulating signal. The driving method enlarges the voltage range of the first electrode of the storage element for enhancing the contrast ratio of the display panel.

### BACKGROUND OF THE INVENTION

1. Field of the Invention

The present invention relates to a pixel unit and driving method thereof, more particularly, to a pixel unit and driving method thereof that alter a reference voltage provided to a storage element.

2. Description of the Related Art

FIG. 1 is a circuit diagram of a display panel. Referring to FIG. 1, the display panel 100 is composed of plural pixel units 110. The pixel units 110 are arranged in a matrix array and each pixel unit 110 is arranged at a crossing region of two adjacent scan lines S1, S2 and two adjacent data lines D1, D2. Each pixel unit 110 includes a switch T1, a pixel electrode Pi coupled to the switch T1, a storage capacitor Cst, and a liquid crystal capacitor Clc. The storage capacitor Cst has a first electrode coupled to the pixel electrode Pi and a second electrode coupled to a common voltage Vcom.

With regard to the semiconductor process, a common electrode (not illustrated in FIG. 1) provided at the display panel is arranged to face the pixel electrode Pi and to be opposite the pixel electrode Pi. A liquid crystal layer is formed between the common electrode and the pixel electrode Pi so that the liquid crystal capacitor Clc equivalently represents a liquid crystal capacitance therebetween. The common electrode often couples to the common voltage Vcom. As shown in FIG. 1, it represents an equivalent circuit of the pixel unit 110. When displaying a frame, each scan line sequentially outputs a scan driving signal to the corresponding switches T1. The ON-OFF state of the switch T1 is performed in response to the scan driving signal. When the switch T1 is turned on, the pixel voltage is supplied to the pixel electrode Pi through the corresponding data line and stored in the corresponding storage capacitor Cst. By applying a voltage between the pixel electrode Pi and the common electrode, the orientation direction of the liquid crystal is changed, and thereby a light transmission of the liquid crystal can be controlled for displaying the frame.

As known, an AC driving is performed in liquid crystal display device for obviating DC residual voltage remained on liquid crystal. To perform the AC driving, also called polarity inversion, the common voltage Vcom applied on the common electrode is used as the reference potential. The pixel voltages having positive polarity and negative polarity with respect to the common voltage Vcom are provided to the pixel electrode Pi in different frame periods. Positive polarity and negative polarity are determined according to the electric field direction applied to liquid crystal. If the voltage of the pixel electrode Pi is greater than the common voltage Vcom, the liquid crystal is driven with positive polarity voltage. Otherwise, the liquid crystal is driven with negative polarity voltage.

As mentioned previously, the switch T1 can be implemented by P-type transistor or N-type transistor, but both of the P-type transistor or N-type transistor are affected by body effect, which results in the restricted range of the pixel voltage stored in the storage capacitor Cst with the fixed common voltage Vcom. It is assumed that the power supply voltages VDDA and VSSA are exemplary 15 volts and 0 volts utilized in the driving system of the display panel 100. If the range of the provided pixel voltage is between 0 volts and 15 volts, due to the body effect, the range of the pixel voltage delivered to the pixel electrode Pi via the switch T1 implemented by the P-type transistor is restricted to be between 5 volts and 15 volts. Accordingly, the common voltage Vcom is set at 10 volts in order to perform polarity inversion. Namely, the pixel voltage between 5 volts and 10 volts serves as negative polarity voltage and the pixel voltage between 10 volts and 15 volts serves as positive polarity voltage with respect to the common voltage Vcom. Consequently, only 5 volts of the pixel voltage range can be applied for representing the gray-scale values of an image and results in poor contrast ratio of the display panel 100.

Similarly, if the switch T1 is implemented by the N-type transistor, due to the body effect, the range of the pixel voltage delivered to the pixel electrode Pi is restricted to be between 0 volts and 10 volts. Accordingly, the common voltage Vcom needs to be set at 5 volts for polarity inversion, and results in the same problem aforementioned. Simply speaking, the switch T1 implemented by transistors can not deliver the full range of the power supply voltages to the pixel electrode Pi because of the characteristic of the electronic components. Therefore, how to increase the maximum voltage range applied to the pixel electrode Pi for controlling the rotation of liquid crystal becomes an important issue for designing the driving system of the display panel.

### SUMMARY OF THE INVENTION

Accordingly, the present invention provides a pixel unit and the driving methods thereof that can make maximum voltage range of the first electrode of the storage element to be close to a full range of power supply voltages and enlarge the voltage range stored in the storage element. The contrast ratio of a display panel can be enhanced since the greater the voltage range stored in the storage element is, the more the details of the image can be displayed.

The pixel unit is provided in the present invention. The pixel unit includes a switch, a storage element and a first multiplexer. The switch develops a charge transfer path according to a scan signal associated with a scan line. The storage element has a first electrode and a second electrode coupled to the switch and a reference voltage respectively for receiving a pixel voltage via the charge transfer path. The first multiplexer coupled to the second electrode of the storage element selectively provides the reference voltage with a default value and the reference voltage with a determined value to the second electrode of the storage element according to a modulating signal.

In an embodiment of the present invention, the pixel unit further includes a second multiplexer coupled to the switch for selectively providing a pixel voltage and a reset voltage to the storage element via the charge transfer path according to a control signal.

A driving method for a pixel unit is provided in the present invention. The pixel unit includes a switch and a storage element, wherein the storage element has a first electrode and a second electrode respectively, coupled to the switch and a reference voltage. In the driving method, a first frame with a first polarity and a second frame with a second polarity are displayed during a first frame period and a second frame period respectively. During the first frame period, a scan signal associated with a scan line is asserted to the switch for developing a charge transfer path. A first pixel voltage is supplied to the first electrode of the storage element via the charge transfer path and the reference voltage is altered from a default value to a determined value during the delivering step. Then the scan signal is de-asserted for terminating the charge transfer path and the reference voltage is altered from the determined value to the default value. During the second frame period, the scan signal associated with the scan line is asserted to the switch for developing the charge transfer path. A second pixel voltage is supplied to the first electrode of the storage element via the charge transfer path. Then the scan signal is de-asserted for terminating the charge transfer path.

A driving method for a pixel unit is provided in the present invention. The pixel unit includes a switch and a storage element, wherein the storage element has a first electrode and a second electrode respectively coupled to the switch and a reference voltage. In the driving method, a first frame with a first polarity and a second frame with a second polarity are displayed during a first frame period and a second frame period respectively. During the first frame period, the scan signal associated with a scan line is asserted to the switch for developing a charge transfer path and a first pixel voltage is supplied to the first electrode of the storage element via the charge transfer path. Then the scan signal is de-asserted for terminating the charge transfer path and the reference voltage is altered from a default value to a determined value. During the second frame period, the reference voltage is altered from the determined value to the default value. Then the scan signal associated with the scan line is asserted to the switch for developing the charge transfer path and a second pixel voltage is supplied to the first electrode of the storage element via the charge transfer path. Next, the scan signal is de-asserted for terminating the charge transfer path.

The present invention provides a pixel unit and the driving methods for the pixel unit that changes the first electrode voltage of the storage element by altering the reference voltage coupled to the second electrode of the storage element according to the characteristic of storage element. Since the potential stored within the storage element is maintained invariable when the pixel voltage is supplied to the storage element, the voltage range of the first electrode of the storage element can be enlarged by altering the second electrode voltage of the storage element and then reacts on the liquid crystal for displaying an image. Therefore, the contrast ratio of a display panel can be enhanced since the greater voltage range stored in the storage element can control the liquid crystal rotating for displaying the more details of the image.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display panel.

FIG. 2A is a circuit diagram of a pixel unit according to an embodiment of the present invention.

FIG. 2B is a timing diagram of the pixel unit according to the embodiment in FIG. 2A.

FIG. 3A is a circuit diagram of a pixel unit according to another embodiment of the present invention.

FIG. 3B is a timing diagram of the pixel unit according to the embodiment in FIG. 3A.

FIG. 4A is a circuit diagram of a pixel unit according to still another embodiment of the present invention.

FIG. 4B is a timing diagram of the pixel unit according to the embodiment in FIG. 4A.

FIG. 5 is a timing diagram of the pixel unit according to the embodiment in FIG. 2A.

FIG. 6 is a timing diagram of the pixel unit according to the embodiment in FIG. 3A.

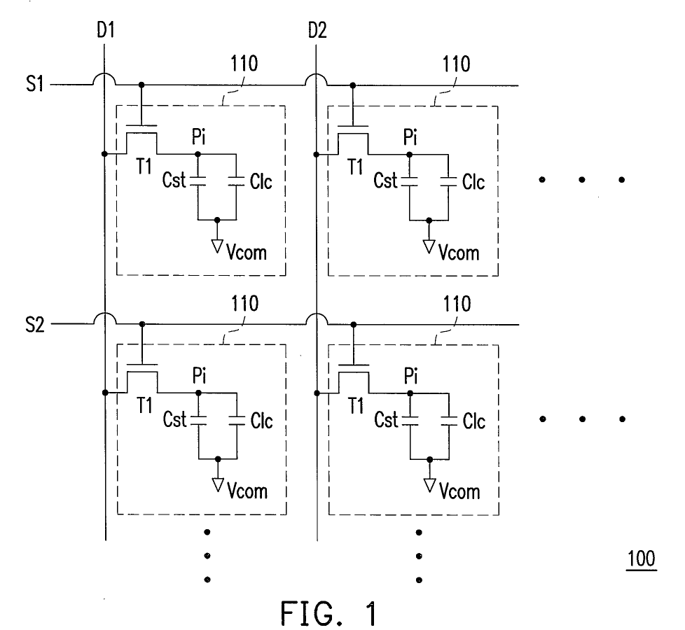

### DESCRIPTION OF THE EMBODIMENTS

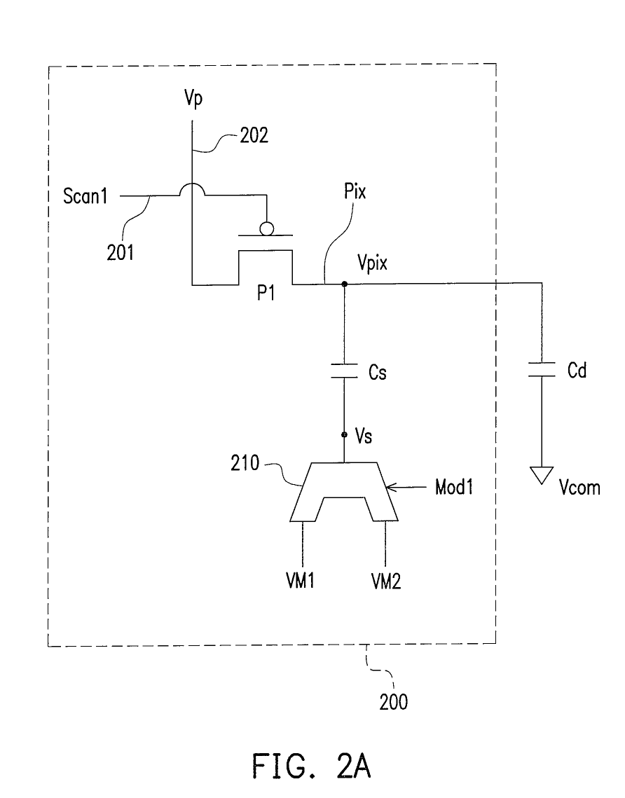

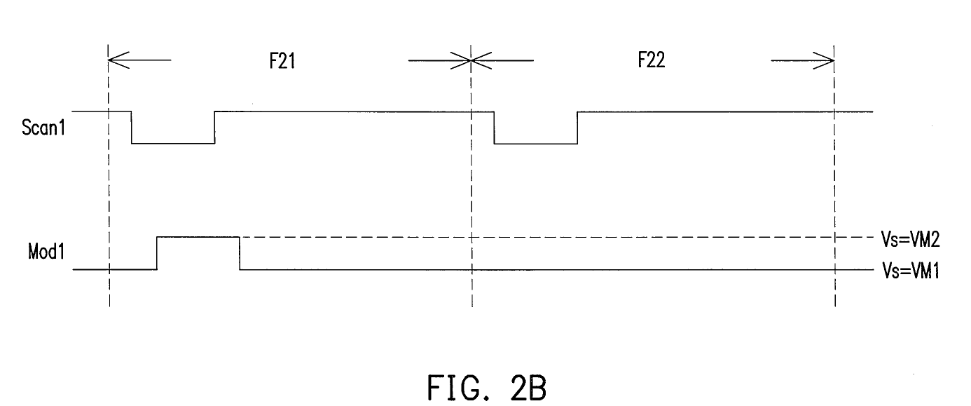

FIG. 2A is a circuit diagram of a pixel unit according to an embodiment of the present invention. Referring to FIG. 2A, the pixel unit 200 includes a switch P1, a pixel electrode Pix coupled to the switch P1, a storage capacitor Cs, and a multiplexer 210, wherein a liquid crystal capacitor Cd represents the liquid crystal layer. The storage capacitor Cs has a first electrode coupled to the pixel electrode Pix and a second electrode coupled to the multiplexer 210. The liquid crystal capacitor Cd represents a liquid crystal capacitance connected between the pixel electrode Pix and a common electrode, wherein the common electrode couples to a common voltage Vcom.

The switch P1, for example, is a P-type transistor in the embodiment, which has a control terminal receiving a scan driving signal Scan1 associated with a scan line 201, a first terminal receiving a pixel voltage Vp through a data line 202, and a second terminal coupled to the pixel electrode Pix. The switch P1 develops a charge transfer path in response to the scan driving signal Scan1. The pixel voltage Vp is supplied to the pixel electrode Pix and stored in the storage capacitor Cs via the charge transfer path. The output terminal of multiplexer 210 is coupled to the second electrode of the storage capacitor Cs, and selectively provides the reference voltage with a default value VM1 and the reference voltage with a determined value VM2 to the second electrode of the storage capacitor Cs according to a modulating signal Mod1, wherein the second electrode voltage of the storage capacitor Cs is denoted as Vs.

The pixel unit 200 can be applied to the liquid crystal display (LCD) panel or the liquid crystal on silicon (LCOS) panel. For describing the operation of the pixel unit 200 in detail, it is assumed that the power supply voltages VDDA and VSSA are exemplary 15 volts and 0 volts in the embodiment, so the range of the pixel voltage Vp provided by the source driver (not illustrated in FIG. 2A) can be between 0 volts and 15 volts for driving liquid crystal. Accordingly, a driving method of the present embodiment which employs the full range of the power supply voltages applied to the pixel electrode Pix without the body effect is performed. In other words, the range of the pixel electrode voltage Vpix applied on the pixel electrode Pix is between 0 volts and 15 volts. The according operations will be described later. To perform said driving method, the common voltage Vcom is used to set at 7.5 volts as the reference potential. For the polarity inversion, the pixel electrode voltage Vpix between 0 volts and 7.5 volts serves as negative polarity voltage and the pixel electrode voltage Vpix between 7.5 volts and 15 volts serves as positive polarity voltage with respect to the common voltage Vcom. Consequently, there are 7.5 volts of the pixel voltage range can be applied to the pixel electrode Pix.

FIG. 2B is a timing diagram of the pixel unit 200 according to the embodiment in FIG. 2A. For describing polarity inversion in the embodiment of the present invention, the frame inversion is performed on the pixel unit 200. Referring to FIG. 2A and FIG. 2B, a frame period F21 and a frame period F22 respectively represent a frame with negative polarity and a frame with positive polarity alternately displayed. In the embodiment of the present invention, the reference voltage with the default value VM1 is set at 7.5 volts, which is equivalent to the common voltage Vcom, and the reference voltage with the determined value VM2 is set at 15 volts. The switch P1 is exemplary used a P-type transistor.

As shown in FIG. 2A and FIG. 2B, when the frame with negative polarity is displayed during the frame period F21, the scan driving signal Scan1 is asserted (logic low for P-type transistor in the embodiment) to conduct the switch P1 and the conducted switch P1 develops the charge transfer path for supplying the pixel voltage Vp to the pixel electrode Pix, wherein the range of the pixel voltage Vp is between 7.5 volts and 15 volts and can be fully delivered to the pixel electrode Pix without body effect. The modulating signal Mod1 of the multiplexor 210 asserted follows the scan driving signal Scan1 and makes the multiplexer 210 provide the reference voltage with the determined value VM2 (i.e. 15 volts) to the second electrode of the storage capacitor Cs. As shown in FIG. 2B, the second electrode voltage Vs of the storage capacitor Cs is altered from the default value VM1 (i.e. 7.5 volts) to the determined value VM2 (i.e. 15 volts). After a sufficient time period for the storage capacitor Cs to charge and store the pixel voltage Vp, the scan signal Scan1 is de-asserted (logic high for P-type transistor in the embodiment) to terminate the charge transfer path. The potential range stored within the storage capacitor Cs is between 0 volts and 7.5 volts.

Then, the modulating signal Mod1 is de-asserted and makes the multiplexer 210 provide the reference voltage with the default value VM1 (i.e. 7.5 volts) to the second electrode of the storage capacitor Cs. In the meanwhile, the second electrode voltage Vs of the storage capacitor Cs is altered from the determined value VM2 (i.e. 15 volts) to the default value VM1 (i.e. 7.5 volts). Since the storage capacitor Cs is able to maintain the potential stored within it invariable and the second electrode voltage Vs is lowered to the reference voltage with the default value VM1 (i.e. 7.5 volts), the range of the pixel electrode voltage Vpix between 7.5 volts and 15 volts is altered to be between 0 volts and 7.5 volts for driving liquid crystal. As mentioned previously, the pixel electrode voltage Vpix between 0 volts and 7.5 volts can serve as negative polarity voltage with respect to the common voltage Vcom. Therefore, the frame with negative polarity is displayed.

Afterward the frame with positive polarity is displayed during the frame period F22, the scan driving signal Scan1 is asserted to conduct the switch P1 and develop the charge transfer path. The pixel voltage Vp between 7.5 volts and 15 volts is supplied to the pixel electrode Pix via the charge transfer path. The modulating signal Mod1 remains constant and makes the multiplexer 210 provide the reference voltage with the default value VM1 (i.e. 7.5 volts) to the second electrode of the storage capacitor Cs. After the sufficient time for the storage capacitor Cs to store the pixel voltage Vp, the scan driving signal Scan1 is de-asserted for terminating the charge transfer path. The potential range stored within the storage capacitor Cs is between 0 volts and 7.5 volts. Accordingly, the pixel electrode voltage Vpix between 7.5 volts and 15 volts, which is same as the range of the pixel voltage Vp, can serve as positive polarity voltage with respect to the common voltage Vcom and the frame with positive polarity is displayed. To sum up, this embodiment utilizes the pixel voltage Vp between 7.5 volts and 15 volts for driving the pixel unit 200, and the range of the pixel electrode voltage Vpix can be enlarged to be nearly equivalent to the range of the power supply voltages VDDA and VSSA without the influences of body effect.

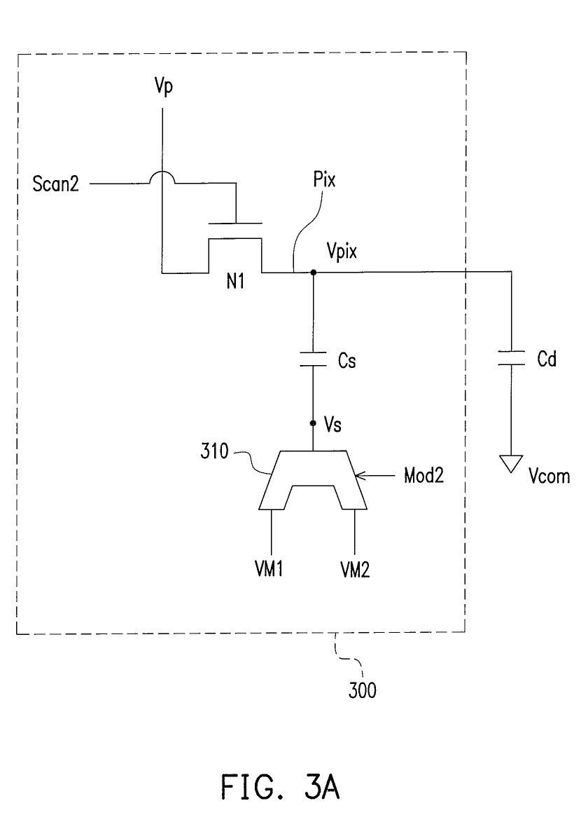

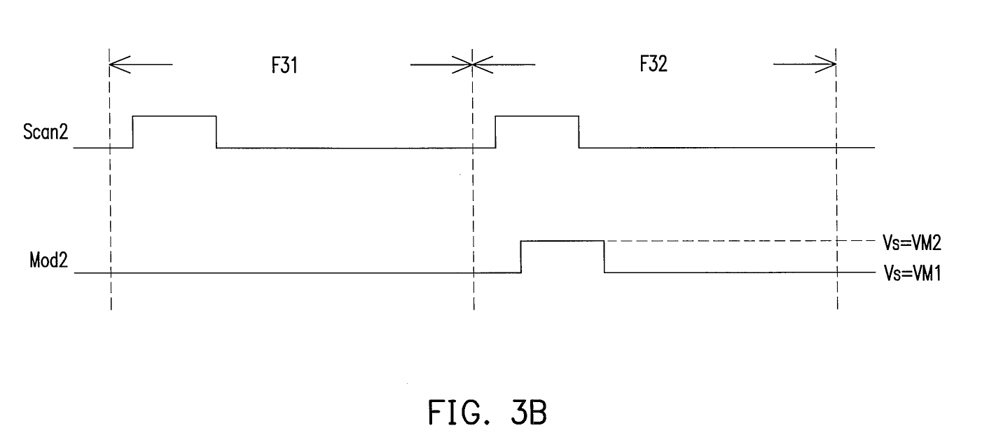

FIG. 3A is a circuit diagram of a pixel unit according to another embodiment of the present invention. Referring to FIG. 2A and FIG. 3A, the difference between the embodiments in FIG. 2A and FIG. 3A is that the switch N1 is implemented by an N-type transistor. In the embodiment of the present invention, the reference voltage with the default value VM1 is set as 7.5 volts, which is equivalent to the common voltage Vcom, and the reference voltage with the determined value VM2 is set as 0 volts. FIG. 3B is a timing diagram of the pixel unit 300 according to the embodiment in FIG. 3A. Referring to FIG. 3B, the frame with negative polarity and the frame with positive polarity are alternately displayed during the frame period F31 and the frame period F32.

When the frame with negative polarity is displayed during the frame period F31, the scan driving signal Scan2 is asserted (logic high for N-type transistor in the embodiment) to conduct the switch N1 for developing the charge transfer path. The pixel voltage Vp is supplied to the pixel electrode Pix via the charge transfer path, wherein the range of the pixel voltage Vp is between 0 volts and 7.5 volts and can be fully delivered to the pixel electrode Pix without body effect. The modulating signal Mod2 remains constant and makes the multiplexer 310 provide the reference voltage with the default value VM1 (i.e. 7.5 volts) to the second electrode of the storage capacitor Cs. After sufficient time for storing the pixel voltage Vp, the scan driving signal Scan2 is de-asserted (logic low for N-type transistor in the embodiment) for terminating the charge transfer path. The potential range stored within the storage capacitor Cs is between 0 volts and 7.5 volts. Accordingly, the pixel electrode voltage Vpix between 0 volts and 7.5 volts, which is same as the range of the pixel voltage Vp, can serve as negative polarity voltage with respect to the common voltage for displaying the frame with negative polarity.

When the frame with positive polarity is displayed during the frame period F32, the scan driving signal Scan2 is asserted for developing the charge transfer path and supplying the pixel voltage Vp between 0 volts and 7.5 volts to the pixel electrode Pix. The modulating signal Mod2 asserted follows the scan driving signal Scan2 and makes the multiplexer 310 provide the reference voltage with the determined value VM2 (i.e. 0 volts) to the second electrode of the storage capacitor Cs. The second electrode voltage Vs of the storage capacitor Cs is altered from the default value VM1 (i.e. 7.5 volts) to the determined value VM2 (i.e. 0 volts). After sufficient time for storing the pixel voltage Vp, the scan driving signal Scan2 is de-asserted for terminating the charge transfer path. The potential range stored within the storage capacitor Cs is between 0 volts and 7.5 volts.

Then, the modulating signal Mod2 is de-asserted and makes the multiplexer 310 provide the reference voltage with the default value VM1 (i.e. 7.5 volts) to the second electrode of the storage capacitor Cs. In the meanwhile, the second electrode voltage Vs of the storage capacitor Cs is altered from the determined value VM2 (i.e. 0 volts) to the default value VM1 (i.e. 7.5 volts). Since the storage capacitor Cs maintains the potential stored within it invariable and the second electrode voltage Vs is risen to the reference voltage with the default value VM1 (i.e. 7.5 volts), the range of the pixel electrode voltage Vpix between 0 volts and 7.5 volts is altered to be between 7.5 volts and 15 volts and can serve as positive polarity voltage with respect to the common voltage Vcom for displaying the frame with positive polarity. Therefore, only the range of the pixel voltage Vp between 0 volts and 7.5 volts is utilized for driving the pixel unit 300, and the range of the pixel electrode voltage Vpix is nearly equivalent to the full range between the power supply voltages VDDA and VSSA in the embodiment.

Referring to FIG. 2A and FIG. 2B, when the frame with negative polarity is displayed during the frame period F21, the scan driving signal Scan1 is asserted for developing the charge transfer path. The pixel voltage Vp between 7.5 volts and 15 volts, is supplied to the pixel electrode Pix via the charge transfer path. If the pixel voltage Vp is an higher voltage, e.g. 15 volts, the pixel electrode voltage Vpix suddenly reaches to a high voltage about 22.5 volts when the second electrode voltage Vs of the storage capacitor Cs is altered from the default value VM1 (i.e. 7.5 volts) to the determined value VM2 (i.e. 15 volts) by the modulating signal Mod1, and this high voltage applied on the pixel electrode Pix may damage the switch P1. Referring to FIG. 3A and FIG. 3B, the pixel unit 300 also has the same problem when the frame with positive polarity is displayed during the frame period F32 and the second electrode voltage Vs of the storage capacitor Cs is altered from the default value VM1 (i.e. 7.5 volts) to the determined value VM2 (i.e. 0 volts). Therefore, when the charge transfer path is developed, the pixel electrode voltage Vpix should be reset before the second electrode voltage Vs of the storage capacitor Cs is altered from the default value VM1 to the determined value VM2.

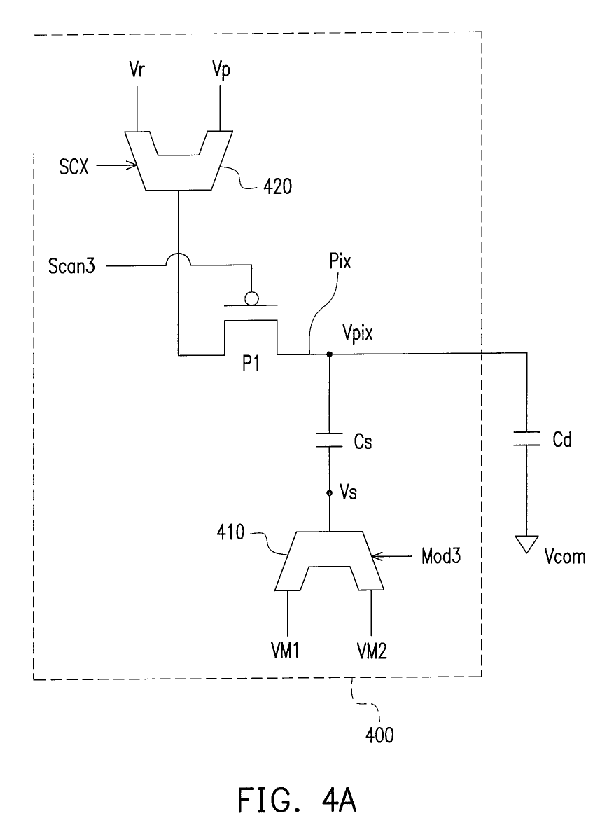

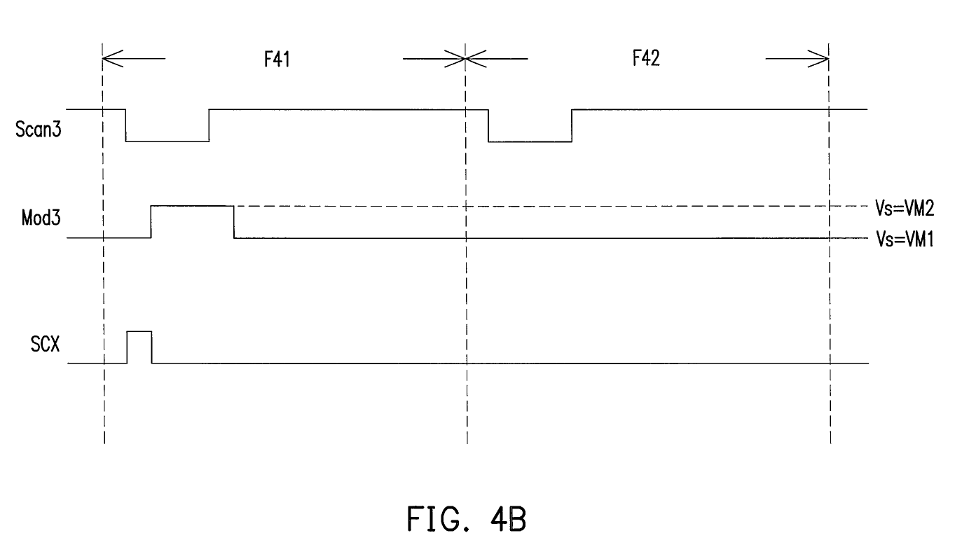

FIG. 4A is a circuit diagram of a pixel unit according to still another embodiment of the present invention. Referring to FIG. 2A and FIG. 4A, the difference between the embodiments in FIG. 2A and FIG. 4A is that the pixel unit 400 further includes a multiplexer 420. The multiplexer 420 is coupled to the switch P1 for selectively providing the pixel voltage Vp and a reset voltage Vr to the pixel electrode Pix via the charge transfer path according to a control signal SCX. FIG. 4B is a timing diagram of the pixel unit 400 according to the embodiment in FIG. 4A. Referring to FIG. 4A and FIG. 4B, when the frame with negative polarity is displayed during the frame period F41, the control signal SCX is asserted and makes the multiplexer 420 provide the reset voltage Vr to the pixel electrode Pix via the charge transfer path after the scan driving signal Scan3 is asserted for developing the charge transfer path and before the modulating signal Mod1 is asserted for altering the second electrode voltage Vs of the storage capacitor Cs from the default value VM1 to the determined value VM2. In the embodiment, the reset voltage Vr can be equal to the reference voltage with the default value VM1, i.e. 7.5 volts. Therefore, when the scan driving signal Scan1 is initially asserted, the potential stored within the storage capacitor Cs can drop to 0 volts for avoiding the switch P1 from being damaged by an over voltage.

To reason by analogy, referring to FIG. 3A and FIG. 3B, the pixel unit 300 can also includes a multiplexer for providing the reset voltage Vr to the pixel electrode Pix after scan driving signal Scan2 is asserted for developing the charge transfer path and before the modulating signal Mod2 is asserted for altering the second the electrode Vs from the default value VM1 (i.e. 7.5 volts) to the determined value VM2 (i.e. 0 volts), when the frame with positive polarity is displayed during the frame period F32. The detail is not iterated.

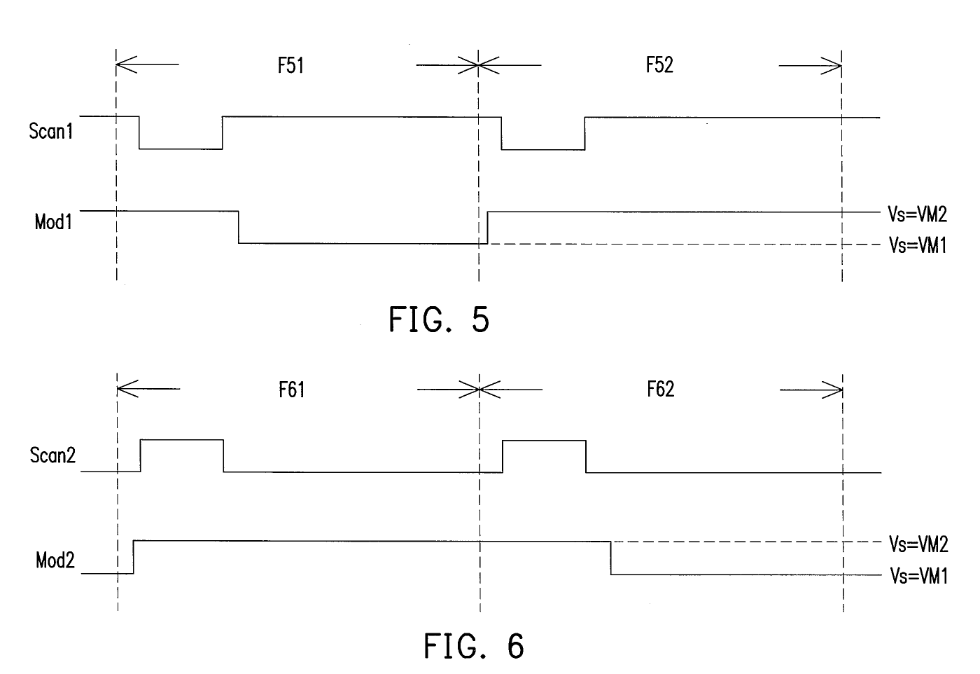

However, the multiplexer 420 may occupy the layout area of the display panel and consumes the cost. There is still another embodiment for improving the withstand voltage problem of the switch. FIG. 5 is a timing diagram of the pixel unit 200 according to the embodiment in FIG. 2A. Referring to FIG. 2A and FIG. 5, when the frame with negative polarity is displayed during the frame period F51, the scan driving signal Scan1 is asserted to conduct the switch P1 for developing the charge transfer path. The pixel voltage Vp between 7.5 volts and 15 volts is supplied to the pixel electrode Pix via the charge transfer path. The modulating signal Mod1 remains constant and makes the multiplexer 210 provide the reference voltage with the determined value VM2 (i.e. 15 volts) to the second electrode of the storage capacitor Cs during the asserted period of the scan signal Scan1. After the sufficient time for storing the pixel voltage Vp, the scan driving signal Scan1 is de-asserted for terminating the charge transfer path. The potential range stored within the storage capacitor Cs is between 0 volts and 7.5 volts.

Then, the modulating signal Mod1 is de-asserted and makes the multiplexer 210 provide the reference voltage with the default value VM1 (i.e. 7.5 volts) to the second electrode of the storage capacitor Cs so that the second electrode voltage Vs of the storage capacitor Cs is altered from the determined value VM2 (i.e. 15 volts) to the default value VM1 (i.e. 7.5 volts) after the charge transfer path is terminated. The operation of this embodiment is similar to the embodiment in FIG. 2A, which alters the range of the pixel electrode voltage Vpix from being between 7.5 volts and 15 volts to be between 0 volts and 7.5 volts for serving as negative polarity voltage. In the embodiment of the present invention, the high voltage will not suddenly occur on the pixel electrode Pix and damage the switch P1 since the altering process is not performed on the second electrode of the storage capacitor Cs during the asserted period of the scan driving signal Scan1.

When the frame with positive polarity is displayed during the frame period F52, the modulating signal Mod1 is asserted and makes the multiplexer 210 provide the reference voltage with the determined value VM2 (i.e. 15 volts) to the second electrode of the storage capacitor Cs before the scan driving signal is asserted. The second electrode voltage Vs of the storage capacitor Cs is altered from the default value VM1 (i.e. 7.5 volts) to the determined value VM2 (i.e. 15 volts). Then the scan driving signal Scan1 is asserted for developing the charge transfer path and the pixel voltage Vp between 7.5 volts and 15 volts is supplied to the pixel electrode Pix via the charge transfer path. After the sufficient time, the scan driving signal Scan1 is de-asserted for terminating the charge transfer path and the modulating signal Mod1 maintain constant. The range of the pixel electrode voltage Vpix is same as the range of the pixel voltage Vp, which is between 7.5 volts and 15 volts, for serving as positive polarity voltages with respect to the common voltage Vcom.

To reason by analogy, FIG. 6 is a timing diagram of the pixel unit 300 according to the embodiment in FIG. 3A. Referring to FIG. 3A and FIG. 6, when the frame with negative polarity is displayed during the frame period F61, the modulating signal Mod2 is asserted for altering the second electrode voltage Vs from the default value VM1 (i.e. 7.5 volts) to the determined value VM2 (i.e. 0 volts) before the charge transfer path is developed. Then, the scan driving signal Scan2 is asserted for developing the charge path and supplying the pixel voltage Vp between 0 volts and 7.5 volts to the pixel electrode Pix, wherein the modulating signal Mod2 maintains constant. Then, the scan driving signal Scan2 is de-asserted for terminating the charge transfer path. The range of the pixel electrode voltage Vpix is same as the range of the pixel voltage Vp, which is between 0 volts and 7.5 volts, for serving as negative polarity voltage with respect to the common voltage Vcom.

When the frame with positive polarity is displayed during the frame period F62, the scan driving signal Scan2 is asserted for developing the charge transfer path and supplying the pixel voltage Vp between 0 volts and 7.5 volts to the pixel electrode Pix. After the scan driving signal Scan2 is de-asserted for terminating the charge transfer path, the modulating signal Mod2 is de-asserted for altering the second electrode voltage Vs of the storage capacitor Cs from the determined value VM2 (i.e. 0 volts) to the default value VM1 (i.e. 7.5 volts) so that the range of the pixel electrode voltage Vpix is altered from being between 0 volts and 7.5 volts to be between 7.5 volts and 15 volts for serving as positive polarity voltage.

In summary, by employing a small range of the pixel voltage, the said embodiments enlarge the range of the pixel electrode voltage Vpix to be nearly equivalent to the range of the power supply voltages VDDA and VSSA for performing the driving of polarity inversion. Besides, the potential range stored within the storage capacitor Cs is also enlarged since the body effect issue is overcome. The greater the voltage range stored in the storage capacitor Cs is employed for representing the gray scales of the image, the more the detail of the image can be displayed.

Furthermore, considering with the issue of the withstand voltage of the switch, the said embodiment in FIG. 4A and FIG. 4B provides the reset voltage Vr to the pixel electrode Pix after the charge transfer path is developed and before the second electrode voltage Vs of the storage capacitor Cs is altered from the default value VM1 to the determined value VM2 for eliminating the potential stored within the storage capacitor Cs when the charge transfer path is initially developed and avoiding the switch P1 from being damaged by the abrupt voltage. Besides, the said embodiments in FIG. 5 and FIG. 6 also design the proper timing control respectively for driving the pixel units 200 and 300 for solving the said problem.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving method for a pixel unit, wherein the pixel unit comprising a switch and a storage element having a first electrode coupled to the switch and a second electrode coupled to a reference voltage, the driving method comprising:
displaying a first frame with a first polarity during a first frame period, comprising:
asserting a first scan signal associated with a scan line to the switch for developing a charge transfer path;
supplying a first pixel voltage to the first electrode of the storage element via the charge transfer path;
altering the reference voltage from a default value to a determined value during the supplying step;
de-asserting the first scan signal for terminating the charge transfer path; and
altering the reference voltage from the determined value to the default value; and
displaying a second frame with a second polarity during a second frame period, comprising:
asserting a second scan signal associated with the scan line to the switch for developing the charge transfer path;
supplying a second pixel voltage to the first electrode of the storage element via the charge transfer path; and
de-asserting the second scan signal for terminating the charge transfer path.

2. The driving method as claimed in claim 1, wherein the first frame and the second frame are alternately displayed.

3. The driving method as claimed in claim 1, wherein the step of displaying the first frame with the first polarity during the first frame period further comprises:
providing a reset voltage to the first electrode of the storage element via the charge transfer path before the altering step.

4. The driving method as claimed in claim 1, wherein the first pixel voltage and the second pixel voltage have same voltage range.

5. The driving method as claimed in claim 4, wherein the voltage range is between the default value and the determined value.

6. The driving method as claimed in claim 1, wherein the pixel unit is capable of composing a liquid crystal display panel.

7. The driving method as claimed in claim 1, wherein the pixel unit is capable of composing a liquid crystal on silicon panel.

8. A driving method for a pixel unit, wherein the pixel unit comprising a switch and a storage element having a first electrode coupled to the switch and a second electrode coupled to a reference voltage, the driving method comprising:
displaying a first frame with a first polarity during a first frame period, comprising:
asserting a first scan signal associated with a scan line to the switch for developing a charge transfer path;
supplying a first pixel voltage to the first electrode of the storage element via the charge transfer path;
de-asserting the first scan signal for terminating the charge transfer path; and
altering the reference voltage from a determined value to a default value; and
displaying a second frame with a second polarity during a second frame period, comprising:
altering the reference voltage from the default value to the determined value;
asserting a second scan signal associated with the scan line to the switch for developing the charge transfer path;
supplying a second pixel voltage to the first electrode of the storage element via the charge transfer path; and
de-asserting the second scan signal for terminating the charge transfer path.

9. The driving method as claimed in claim 8, wherein the first frame and the second frame are alternately displayed.

10. The driving method as claimed in claim 8, wherein the first pixel voltage and the second pixel voltage have same voltage range.

11. The driving method as claimed in claim 10, wherein the voltage range is between the default value and the determined value.

12. The driving method as claimed in claim 8, wherein the pixel unit is capable of composing a liquid crystal display panel.

13. The driving method as claimed in claim 8, wherein the pixel unit is capable of composing a liquid crystal on silicon panel.

14. A pixel unit for a display device, comprising:
a switch for developing a charge transfer path according to a scan signal associated with a scan line;
a storage element having a first electrode coupled to the switch and a second electrode coupled to a reference voltage for receiving a pixel voltage via the charge transfer path; and
a first multiplexer coupled to the second electrode of the storage element for selectively providing the reference voltage with a default value and the reference voltage with a determined value to the second electrode of the storage element according to a modulating signal.

15. The pixel unit as claimed in claim 14, further comprising:
a second multiplexer coupled to the switch for selectively providing the pixel voltage and a reset voltage to the storage element via the charge transfer path according to a control signal.

16. The pixel unit as claimed in claim 14, wherein the voltage range of the pixel voltage is between the default value and the determined value.

17. The pixel unit as claimed in claim 14, wherein the switch is NMOS transistor or PMOS transistor.

18. The pixel unit as claimed in claim 14, wherein the display device is a liquid crystal display.

19. The pixel unit as claimed in claim 14, wherein the display device is a liquid crystal on silicon display
